(19) United States
(12) Patent Application Publication
(10) Pub. No.: US 2026/0162920 A1
(43) Pub. Date: Jun. 11, 2026

(54) SWITCHING APPARATUS FOR ELECTRICAL SYSTEMS

(71) Applicant: ABB S.p.A., Milano (IT)

(72) Inventors: Pierantonio Arrighetti, Bossico (BG) (IT); Pierre Corfdir, Wettingen (CH)

(21) Appl. No.: 19/181,575

(22) Filed: Apr. 17, 2025

(30) Foreign Application Priority Data
Apr. 24, 2024 (EP) 24172110.9

(51) Int. Cl. H01H 71/02; H01H 71/08

(52) U.S. Cl. CPC H01H 71/0207; H01H 71/0271; H01H 71/08; H01H 2205/002

(57) ABSTRACT

A low-voltage switching apparatus is disclosed which comprises a switching device having one or more switch poles. Each switch pole comprises first and second pole terminals that can be coupled with corresponding line conductors of an electric line; a fixed contact assembly is connected to the first pole terminal and includes first fixed contacts and second fixed contacts electrically insulated from the first fixed contacts; and a movable contact assembly connected to the second pole terminal and including first movable contacts and second movable contacts. The switching apparatus comprises, for each switch pole, a current limiter connected with the second fixed contacts and the first pole terminal of the switch pole. Each current limiter is configured to limit a current flowing along a series circuit including at least the second fixed contacts, the current limiter and the first pole terminal, during an opening maneuver of the switching device.

### CROSS REFERENCE TO RELATED APPLICATIONS

The present application claims priority to European Patent Application No. 24172110.9 filed on Apr. 24, 2024, and titled “SWITCHING APPARATUS FOR ELECTRICAL SYSTEMS”, which is hereby incorporated by reference in its entirety.

### TECHNICAL FIELD

The present disclosure relates to a switching apparatus for electrical systems, in some embodiments low-voltage electrical systems.

### BACKGROUND

Low-voltage switching devices, such as for example circuit breakers, disconnectors, contactors, or the like, comprise one or more switch poles, each including one or more fixed contacts and movable contacts that can be coupled to and uncoupled from one another.

As is known, during an opening maneuver of a switching device, electric arcs may arise between the electric contacts under separation of the switch poles, particularly under stress conditions (e.g., in presence of overload currents or short-circuit currents).

To break currents circulating along the switch poles, such arcing phenomena must be extinguished as quickly as possible. To this aim, a switching device generally comprises, for each switch pole, an arc chamber including suitable arc-breaking elements positioned near the electric contacts and designed to split possible electric arcs arising between the electric contacts. Unfortunately, the arc-quenching action exerted by the arc-breaking elements is not always uniform and efficient, which may adversely affect the lifetime of the arc chamber itself and lead to an early decay of its functionalities, thereby remarkably limiting the overall performances of the switching device.

Moreover, it has been seen that electric arcs may sometime strike towards other conductive parts of the switch pole, which are located outside the arc chamber of the switch pole. The components of the switching device, which are possibly affected by these electric arcs, may be subject to serious damages, since they are not generally designed to bear high electric and thermal stresses. The above-mentioned inconveniences are even made more critical by the circumstance that, in modern electric power distribution grids, switching devices are often brought to operate to relatively high operating voltages (e.g., up to 2.0-2.5 kV either AC or DC). High power electric arcs may therefore arise between the electric contacts under separation during the opening maneuver of the switching device.

In the state of the art, it is quite felt the need for innovative solutions, which allows overcoming or mitigating the above-mentioned problems.

### BRIEF DESCRIPTION

The present disclosure intends to respond to this need by providing a switching apparatus, according to the following claim 1 and the related dependent claims.

The switching apparatus, according to the present disclosure, comprises a switching device including one or more switch poles.

Each switch pole comprises a first pole terminal and a second pole terminal configured to be coupled with corresponding line conductors of an electric line.

Each switch pole comprises a fixed contact assembly including a plurality of fixed electric contacts electrically connected to said first pole terminal. Said fixed electric contacts include one or more first fixed contacts and one or more second fixed contacts electrically insulated from said first fixed contacts.

Each switch pole comprises a movable contact assembly including a plurality of movable electric contacts electrically connected to said second pole terminal. Said movable electric contacts include one or more first movable contacts and one or more second movable contacts.

The movable contact assembly of each switch pole is reversibly movable around a rotation axis, so that said first movable contacts can be coupled to or decoupled from said first fixed contacts and said second movable contacts can be coupled to or decoupled from said second fixed contacts, when said movable contact assembly moves about said rotation axis.

The switching apparatus, according to the present disclosure, comprises a current limiter for each switch pole of said switching device.

Each current limiter is electrically connected in series with the second fixed contacts and the first pole terminal of the corresponding switch pole.

Said current limiter is configured to limit or break a current flowing along a series circuit including at least said second fixed contacts, said current limiter and said first pole terminal, during an opening maneuver of said switching device, when the first movable electric contacts of said movable contact assembly decouple from the first fixed contacts of said fixed contact assembly.

The movable contact assembly of each switch pole is reversibly movable, about said rotation axis, between a first position, which corresponds to a closed condition of said switch pole, and a second position, which corresponds to an open condition of said switch pole.

When said movable contact assembly is in said first position said first movable contacts are coupled to said first fixed contacts and said second movable contacts are decoupled from said second fixed contacts.

When said movable contact assembly is in said second position, said first movable contacts are decoupled from said first fixed contacts and said second movable contacts are decoupled from said second fixed contacts.

During an opening maneuver of said switching device, said movable contact assembly moves from said first position to a first intermediate position, in which said first movable contacts are coupled to said first fixed contacts and said second movable contacts are coupled to said second fixed contacts.

Said movable contact assembly subsequently moves from said first intermediate position to a second intermediate position, in which said first movable contacts are decoupled from said first fixed contacts and said second movable contacts are coupled to said second fixed contacts.

Said movable contact assembly subsequently moves from said second intermediate position to the above-mentioned second position, at which also said second movable contacts are decoupled from said second fixed contacts. The second movable contacts decouple from said second fixed contacts while the movable contact assembly is travelling from said second intermediate position to said second position.

The current limiter electrically connected to said switch pole is configured to limit or break a current flowing along the series circuit including at least said second fixed contacts, said current limiter and said first pole terminal, when said movable contact assembly reaches said second intermediate position and when said movable contact assembly moves from said second intermediate position to said second position.

According to some embodiments, the switching apparatus of the present disclosure comprises an auxiliary switching device of the electro-mechanical type electrically connected to the switch poles of said switching device. Each current limiter of said switching apparatus is formed by a switch pole of said auxiliary switching device.

According to other embodiments, each current limiter of said switching apparatus includes an auxiliary switching device of the electro-mechanical type electrically connected to a corresponding switch pole of said switching device. In some embodiments, said auxiliary switching device has a plurality of switch poles electrically connected in series.

According to other embodiments, each current limiter of said switching apparatus includes a switching circuit of the solid-state type based on semiconductors electrically connected to a corresponding switch pole of said switching device.

According to other embodiments, each current limiter of said switching apparatus includes a fuse circuit electrically connected to a corresponding switch pole of said switching device.

According to other embodiments, each current limiter of said switching apparatus includes a resistive circuit electrically connected to a corresponding switch pole of said switching device.

According to other embodiments, each current limiter of said switching apparatus includes a resonant circuit electrically connected to a corresponding switch pole of said switching device.

According to other embodiments, each current limiter of said switching apparatus comprises a hybrid switching circuit electrically connected to a corresponding switch pole of said switching device. Such a hybrid switching circuit comprises at least a switching device of the electro-mechanical type and at least a switching circuit of the solid-state type mutually combined.

According to some embodiments of the present disclosure, the switching apparatus comprises, for each switch pole of said switching device, a magnetic field generation arrangement including a first coil conductor and a second coil conductor wound around a winding axis parallel to the rotation axis of the movable contact assembly of said switch pole.

Said first and second coil conductors are spaced one from another along said winding axis and are electrically connected in series with the second fixed contacts of said switch pole, a current limiter and the first pole terminal of said switch pole.

The current limiter electrically connected to said switch pole is configured to limit or break a current flowing along a series circuit including at least said second fixed contacts, said first coil conductor, said current limiter, said second coil conductor and said first pole terminal, during an opening maneuver of said switching device, when said first movable electric contacts decouple from said first fixed contacts, more particularly when the movable contact assembly of said pole reaches said second intermediate position and moves from said second intermediate position to said second position.

### BRIEF DESCRIPTION OF DRAWINGS

Further features and advantages of the present disclosure will be evident from the description of non-exclusive embodiments of a switch pole, according to the present disclosure, shown by way of examples in the accompanying drawings.

FIG. 1 shows a schematic view of an embodiment of the switching apparatus, according to the present disclosure.

FIG. 2 shows a schematic view of another embodiment of the switching apparatus, according to the present disclosure.

FIGS. 3-5 show schematic views of an electric pole of a switching device included in the switching apparatus of FIGS. 1-2.

FIG. 6 shows a schematic circuit view of the switching apparatus of FIGS. 1-2, for a generic electric phase.

FIG. 7 shows a schematic circuit view of a variant of the switching apparatus of FIG. 1, for a generic electric phase.

FIG. 8 shows a schematic circuit view of a variant of the switching apparatus of FIG. 2, for a generic electric phase.

FIGS. 9-18 are schematic views showing the operation of the switching apparatus of FIGS. 1-2, during an opening maneuver of the switching device.

FIG. 19 shows a schematic circuit view of the switching apparatus, according to a further embodiment of the present disclosure, for a generic electric phase.

### DETAILED DESCRIPTION

With reference to the attached figures, the present disclosure relates to a switching apparatus 500 adapted for installation in AC or DC low-voltage electrical systems.

For the purposes of the present disclosure, the term “low-voltage” typically relates to operating voltages up to 2.0 kV AC and 2.5 kV DC.

According to the present disclosure, the switching apparatus 500 comprises a switching device 100, e.g., a circuit breaker, a disconnector, a contactor, or the like.

The switching device 100 comprises one or more switch poles 1.

The number of switch poles of the switching device 100 may vary according to the needs. As an example, the switching device 100 may be of the three-phase type and thus comprise three switch poles. However, in principle, the switching device may include a different number of switch poles.

Each switch pole 1 of the switching device 100 comprises a first pole terminal 7 and a second pole terminal 8 that can be coupled with corresponding line conductors of an electric line.

In operation, the pole terminals 7, 8 are electrically coupled (in a known manner) with corresponding line conductors of an electric line. Such line conductors are, in turn, electrically connected to an electric power source (e.g., an electric power feeding or generation system or a section of electric grid) and to an electric load (e.g., an electric system or apparatus or a section of electric grid), respectively.

For the sake of clarity, it is specified that the terms “coupled”, “decoupled” used in this disclosure relate to both an electrical and mechanical coupling/decoupling of different parts unless otherwise specified or self-evident from the description or figures.

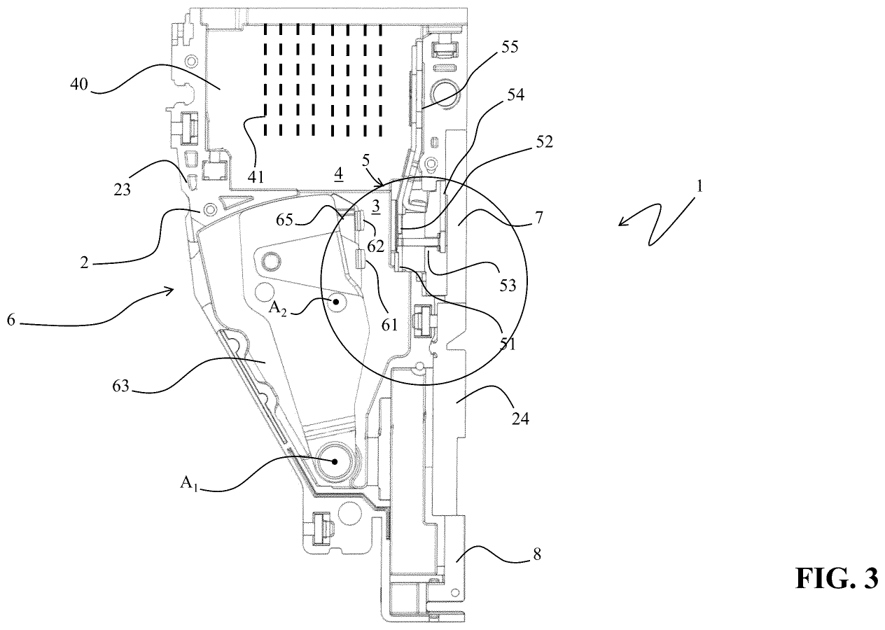

In some embodiments, the switch pole 1 comprises an insulating casing 2 defining an internal volume including a contact region 3 and an arc extinguishing region 4 (FIG. 3).

In general, the contact region 3 is a portion of internal volume of the switch pole where the contact assemblies of the switch pole are arranged and operate. On the other hand, the arc-extinguishing region 4 is a portion of internal volume of the switch pole where there are arranged suitable arc-quenching means designed to extinguish possible electric arcs arising between the electric contacts of the switch pole, during the opening maneuver.

In some embodiments, the contact region 3 and the arc extinguishing region 4 are adjacent and in fluid-dynamic communication one with another. In some embodiments, the arc extinguishing region 4 is positioned at an upper level with respect to the contact region 3, i.e., in proximal position relative to a top side of the latter.

For the sake of clarity, it is specified that relative terms used in this disclosure, e.g., “front”, “rear”, “lateral”, “upper”, “lower”, “top” and “bottom” relate to the switch pole 1 in its normal installation conditions, namely in the “vertical” installation (FIG. 3).

The insulating casing 2 of the switch pole is shaped as a contoured box with opposite first and second lateral walls, opposite top and bottom walls and opposite front and rear walls 23, 24.

In some embodiments, the above-mentioned pole terminals 7, 8 are positioned at the rear wall 24 of the insulating casing of the switch pole.

In some embodiments, the insulating casing 2 is made of an electrically insulating material, e.g., a thermosetting or thermoplastic material.

According to the present disclosure, a switch pole 1 comprises a fixed contact assembly 5 and a movable contact assembly 6 arranged in the contact region 3 of the switch pole (FIGS. 3, 9-14).

The fixed contact assembly 5 comprises one or more fixed electric contacts 51, 52 that, in general, are electrically connected to the first pole terminal 7.

More particularly, the fixed contact assembly 5 includes one or more first fixed contacts 51 and one or more second fixed contacts 52, which are spaced apart from the fixed contacts 51 and electrically insulated from these latter.

The first and second fixed contacts 51, 52 are therefore electrically connected to the first pole terminal 7 but they are mutually spaced.

In some embodiments, the first and second fixed contacts 51, 52 are positioned at the rear wall 24 of the insulating casing of the switch pole.

In some embodiments, the first and second fixed contacts 51, 52 are arranged respectively in distal position and in proximal position relative to the arc-extinguishing region 4 of the switch pole.

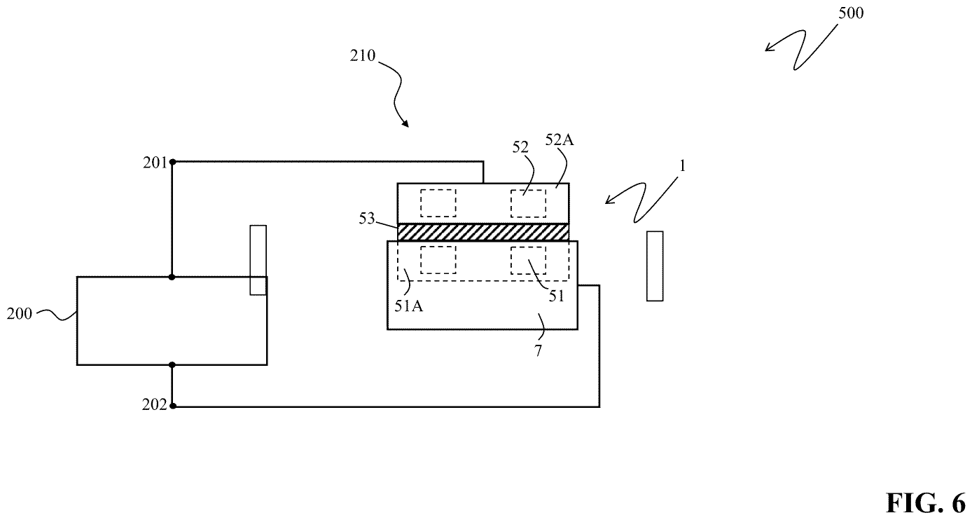

In some embodiments, the first fixed contacts 51 are formed by a pair of conductive tips arranged on a first conductive base 51A directly coupled to the first pole terminal 7 (FIGS. 6-8, 11-19).

Similarly, in some embodiments, the second fixed contacts 52 are formed by a pair of conductive tips arranged on a second conductive base 52A electrically connected to the first pole terminal 7 through other conductive components of the switch pole as it will become more evident from the following.

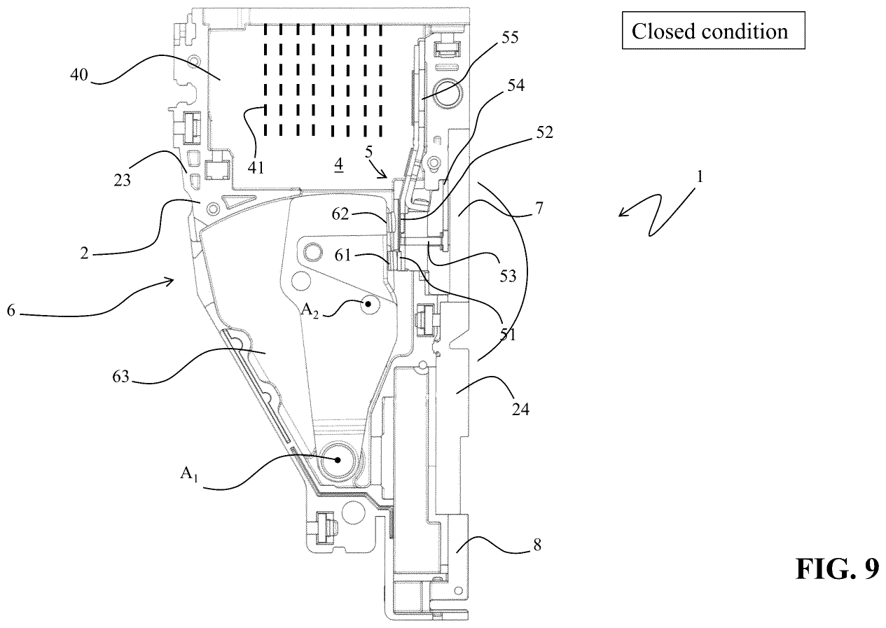

In some embodiments, the first and second fixed contacts 51, 52 protrude at different heights relative to a common reference plane defined by the respective conductive bases 51A, 52A. More particularly, the first fixed contacts 51 protrude at a greater height compared to the second fixed contacts 52 (FIGS. 9-14).

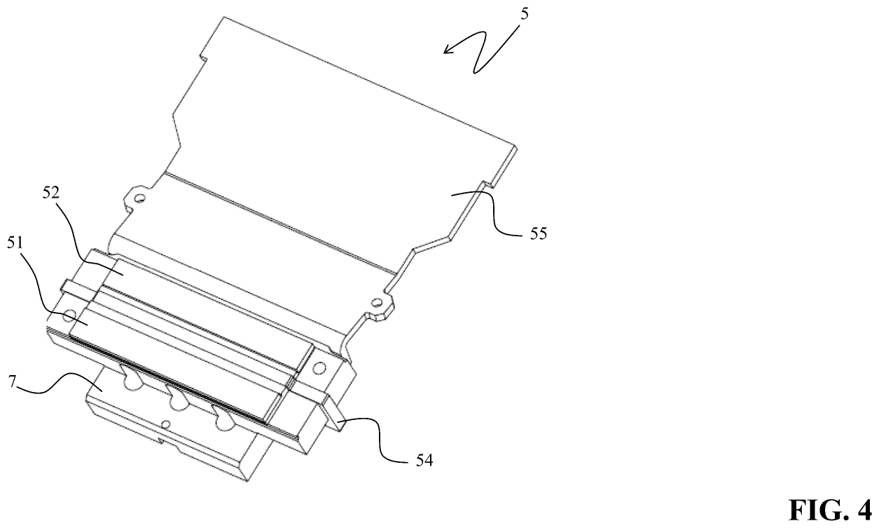

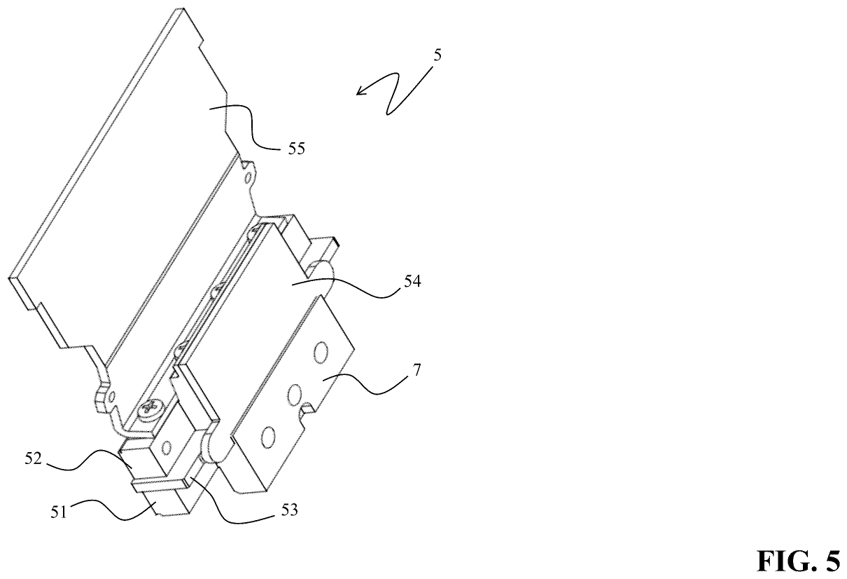

In some embodiments, the fixed contact assembly 5 comprises a first spacer 53 of electrically insulating material interposed between the first and second fixed contacts 51, 52 in order to insulate electrically these latter one from another (FIGS. 3-5, 9-14).

In some embodiments, the fixed contact assembly 5 comprises a second spacer 54 of electrically insulating material interposed between the first pole terminal 7 and the second fixed contacts 52 in order to prevent a direct electrical coupling between these components (which are mutually connected through other conductive components of the switch pole as it will become clearer from the following).

In some embodiments, the fixed contact assembly 5 comprises an elongated conductive plate 55 (e.g., formed by a metal material) electrically connected to the second fixed contacts 52. The conductive plate 55 extends from the second fixed contacts 52 towards the arc extinguishing region 4 and it is arranged at the rear wall 24 of the insulating casing 2 (FIGS. 3-5).

The movable contact assembly 6 comprises one or more movable electric contacts 61, 62 that are, in general, electrically connected to the second pole terminal 8 (FIGS. 3, 9-14).

More particularly, the movable contact assembly 6 includes one or more first movable contacts 61 and one or more second movable contacts 62.

In some embodiments, the first and second movable electric contacts 61, 62 are electrically connected one to another and electrically connected to the second pole terminal 8.

In some embodiments, the first and second movable contacts 61, 62 are arranged in distal position and in proximal position relative to the arc-extinguishing region 4 of the switch pole, respectively.

In some embodiments, the first and second movable contacts 61, 62 are formed by first and second pairs of conductive fingers, respectively, which protrude from a conductive head 65 electrically connected to the second pole terminal 8.

The movable contact assembly 6 is reversibly movable around a rotation axis A₁, which in some embodiments is perpendicular to the lateral walls of the insulating casing of the switch pole (such a rotation axis A₁ is perpendicular the plane of FIGS. 3, 9-14).

In some embodiments, the movable contact assembly 6 comprises a supporting structure 63 for the movable contacts 61, 62. Such a supporting structure can conveniently rotate about the rotation axis A₁ and it comprises a connecting element 64, which protrudes outside the insulating casing of the switch pole (in some embodiments from a suitable window of the front wall 23) for connection with a driving mechanism (not shown).

In some embodiments, the conductive head 65 on which the movable contacts 61, 62 are mounted, is hinged to the supporting structure 63. The conductive head 65 thus rotates together with the supporting structure 63 and it can slightly rotate about a further rotation axis A₂ relative to said supporting structure, when this latter moves.

In this way, when the supporting structure 63 rotates according to a rotation direction, the conductive head 65 can tilt slightly with an opposite rotation movement relative to the supporting structure 63.

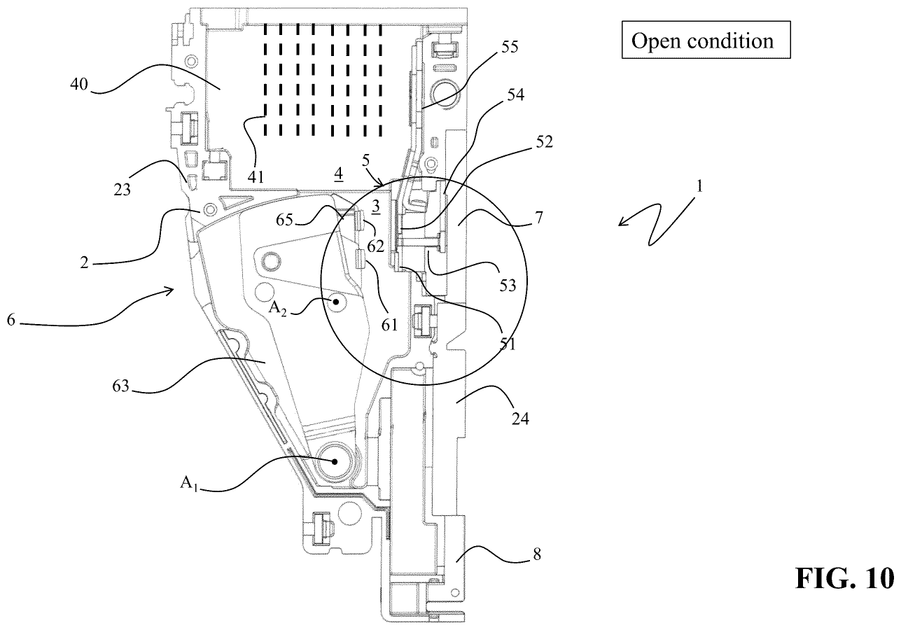

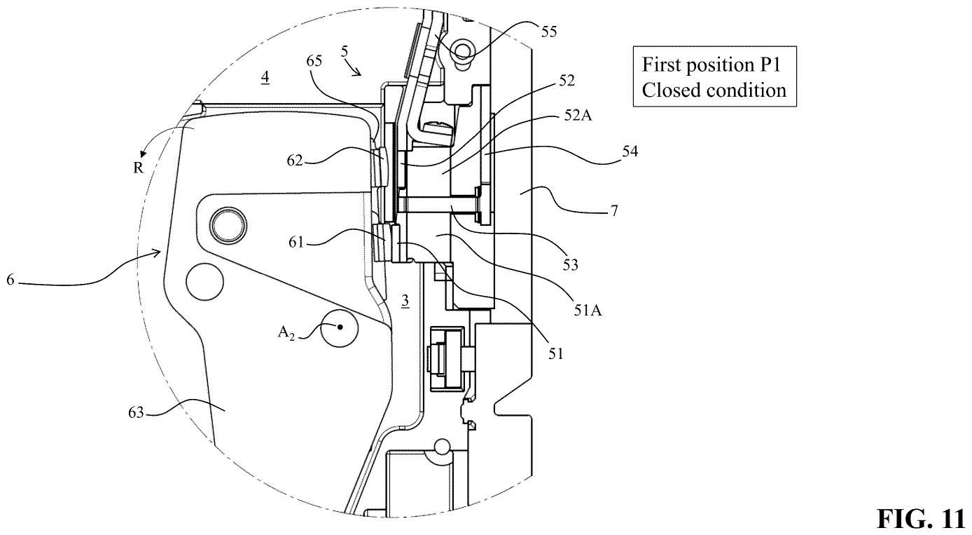

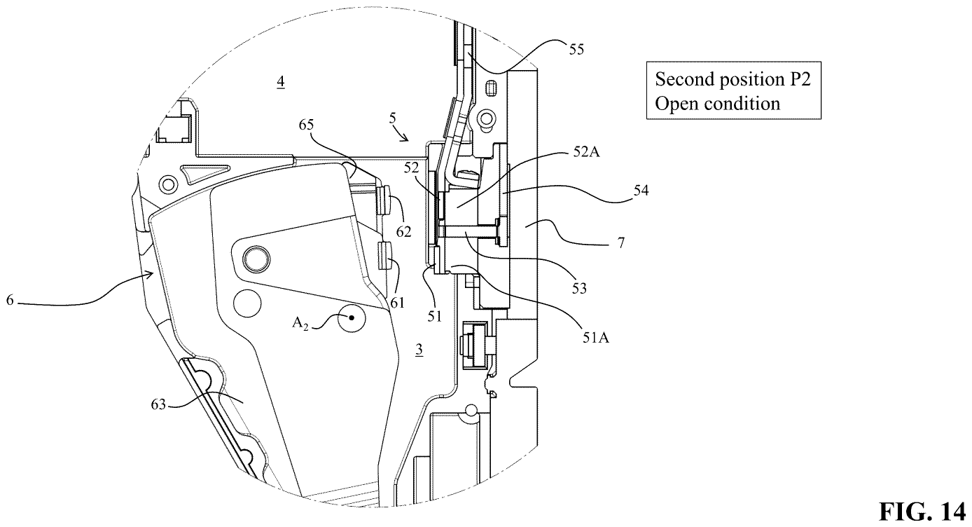

The movable contact assembly 6 is movable, about the rotation axis A₁, between a first position P₁ (FIGS. 9 and 11) and a second position P₂ (FIGS. 10 and 14).

In this way, the first movable contacts 61 can be coupled to or decoupled from the first fixed contacts 51 while the second movable contacts 62 can be coupled to or decoupled from the second fixed contacts 52.

The first position P₁ of the movable contact assembly 6 corresponds to a closed condition of the switch pole, in which electric currents are allowed to flow between the pole terminals of the switch pole, whereas the second position P₂ of the movable contact assembly 6 corresponds to an open condition of the switch pole, in which electric currents flowing along the switch pole are interrupted.

Conveniently, the movable contact assembly 6 moves between the first and second positions P₁, P₂ by rotating about the rotation axis A₁ according to opposite rotation directions.

A transition of the movable contact assembly 6 from the first position P₁ to the second position P₂, for each switch pole, constitutes an opening maneuver of the switching device 100.

An opposite transition of the movable contact assembly 6 from the second position P₂ to the first position P₁, for each switch pole, constitutes a closing maneuver of the switching device 100.

Advantageously, the movable contact assembly 6 and the fixed contact assembly 5 are arranged so that the first and second movable contacts 61, 62 decouple from the first and second fixed contacts 51, 52, according to a specific opening sequence (described in the following), during an opening maneuver of the switch pole (FIGS. 11-14).

When the movable contact assembly 6 is in the first position P₁ (closed condition of the switch pole), the first movable contacts 61 are coupled to the first fixed contacts 51 while the second movable contacts 62 are decoupled from the second fixed contacts 52 (FIG. 11).

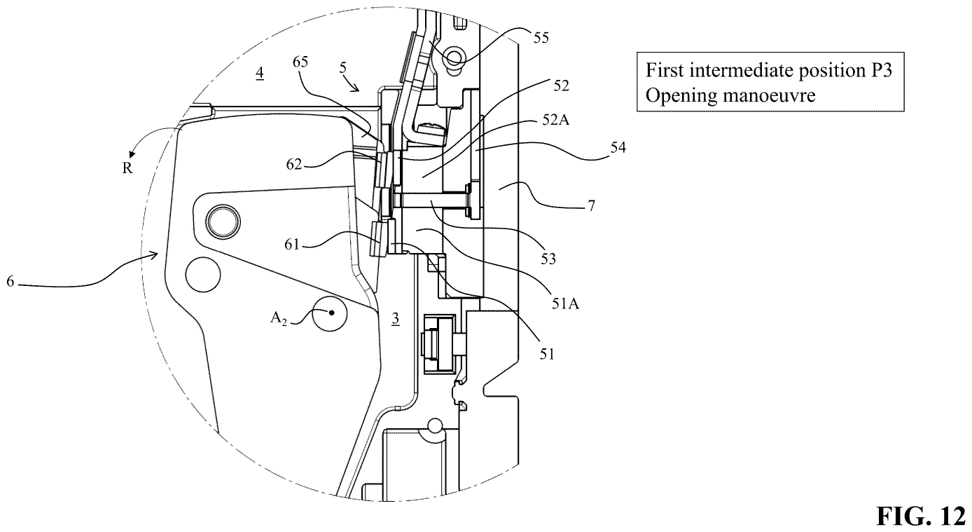

During an opening maneuver of the switch pole, upon an initial movement according to a rotation direction R about the rotation axis A₁ (FIGS. 11-12), the movable contact assembly 6 moves from the first position P₁ to a first intermediate position P₃ (FIG. 12), in which the first movable contacts 61 are coupled to the first fixed contacts 51 and the second movable contacts 62 are coupled to the second fixed contacts 52. The first movable contacts 61 rotate about the rotation axis A₂, when the movable contact assembly 6 moves from the first position P₁ to a first intermediate position P₃.

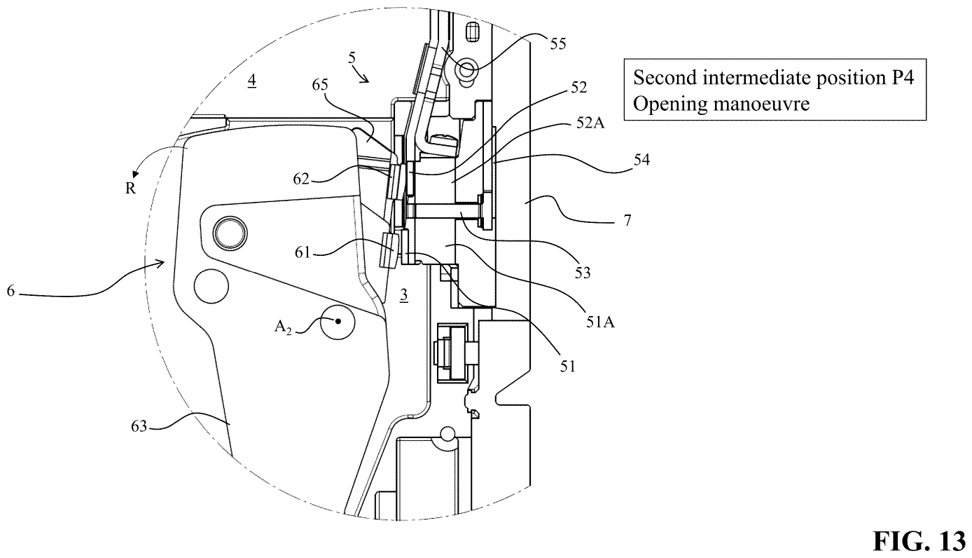

Upon a further movement according to the rotation direction R (FIGS. 12-13), the movable contact assembly 6 moves from the first intermediate position P₃ to a second intermediate position P₄ (FIG. 13), in which the first movable contacts 61 are decoupled from the first fixed contacts 51 and the second movable contacts 62 are coupled to the second fixed contacts 52.

Upon yet a further movement according to a rotation direction R (FIGS. 13-14), the movable contact assembly 6 moves from the second intermediate position P₄ to the

second position P₂ (FIG. 14).

When the movable contact assembly 6 is the second position P₂, the first movable contacts 61 are decoupled from the first fixed contacts 51 while the second movable contacts 62 are decoupled from the second fixed contacts 52. The second movable contacts 62 decouple from the second fixed contacts 52 while the movable contact 6 is travelling from the second intermediate position P₄ to the second position P₂.

As it is evident from FIGS. 11-14, the implementation of the above-described opening sequence of the electric contacts 51, 52, 61, 62 is made possible by the special arrangement of the movable contacts 61, 62 (which are mounted on the tilting head 65) and the special arrangement of the fixed contacts 51, 52 (which protrude at different heights from the respective conductive bases 51A, 52A).

Advantageously, the movable contact assembly 6 and the fixed contact assembly 5 are arranged so that the first and second movable contacts 61, 62 couple to the first and second fixed contacts 51, 52, according to a specific closing sequence, during a closing maneuver of the switch pole. The closing sequence of the electric contacts is substantially opposite compared to the opening sequence described above. No electric arcs arise during a closing maneuver of the switch pole.

In some embodiments, the switch pole 1 comprises an arc chamber 40 positioned in the arc extinguishing region 4, conveniently above the contact region 3 (FIGS. 3, 9-10).

The arc chamber 40 comprises a plurality of arc-breaking elements 41 designed to extinguish possible electric arcs arising between the electric contacts 51, 52, 61, 62 when these latter separate during an opening maneuver of the switch pole (FIGS. 11-14).

The arc-breaking elements 41 of the arc chamber 40 include a series of arc-breaking plates arranged in parallel, in some embodiments along reference planes parallel to the front and rear walls 23, 24 and perpendicular to the lateral walls 21, 22 of the insulating casing 2. In some embodiments arc-breaking plates 41 are arranged at subsequent positions between the front and rear walls 23, 24, at increasing distances from the fixed contact assembly 5.

In some embodiments, the arc-breaking plates 41 are formed by contoured metallic or ceramic plates, which can have different dimensions and shapes according to the needs.

According to the present disclosure, the switching apparatus 500 comprises a current limiter 200 for each switch pole of the switching device 100.

Each current limiter 200 is configured to limit or break currents flowing along a corresponding switch pole 1 of the switching device 100, during an opening maneuver of said switching device, particularly when the first movable electric contacts 61 of the switch poles decouple from the first fixed contacts 51 and the current flowing along the switch pole fully passes through the second movable contacts 62 and the second fixed contacts 52 of the switch pole because these electric contacts are still coupled or because electric arcs arise between these electric contacts.

Each current limiter 200 effectively contributes to quench possible electric arcs arising between the movable contact assembly 6 and the fixed contact assembly 5 as it intervenes during the most critical phases of the opening maneuver when the movable contact assembly 6 is separating from the fixed contact assembly 5 and electric arcs may strike between the electric contacts of the switch pole.

According to the present disclosure, each current limiter 200 is electrically connected in series with the second fixed contacts 52 and the first pole terminal 7 of a corresponding switch pole 1.

FIG. 6 shows a schematic circuit view of the switching apparatus, for a generic electric phase.

For each electric phase, the switching apparatus 500 comprises a switch pole 1 of the switching device 100 and a current limiter 200 electrically connected one to another.

The current limiter 200 comprises a first terminal 201, which is electrically connected with the second fixed contacts 52 (conveniently with the conductive base 52A supporting said fixed contacts) of the switch pole 1, and a second terminal 202, which is electrically connected with the first pole terminal 7 of the switch pole 1.

The second fixed contacts 52, the current limiter 200 and the first pole terminal 7 thus form a series circuit 210, along which a current can flow during an opening maneuver of the switching device 100.

Each current limiter 200 may include a plurality of current limiting units (even of different type) electrically connected in series, in parallel or in series-parallel, according to the needs.

The current limiter 200 is configured to limit or break a current flowing along the series circuit 210, when the first movable electric contacts 61 of the switch pole 1 decouple from the corresponding first fixed electric contacts 51.

The operation of the switching apparatus 500, for a generic electric phase, is now described in more details with reference to FIGS. 9-18.

FIG. 11 shows the switch pole 1 of the switching device 100 with the movable contact assembly 6 in the first position P₁ (closed condition of the switch pole).

In this situation, the first movable contacts 61 are coupled to the first fixed contacts 51 while the second movable contacts 62 are decoupled from the second fixed contacts 52.

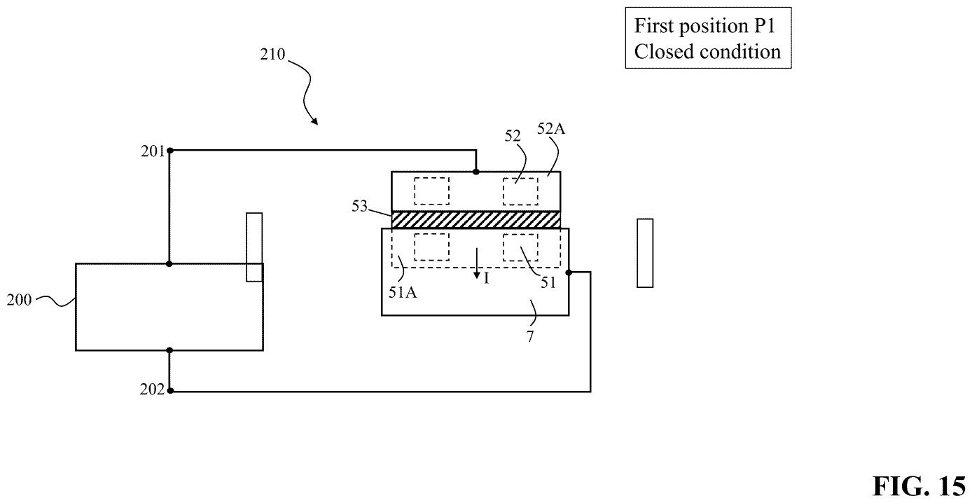

A pole current I can flow along the switch pole between the pole terminals 7, 8. The pole current I passes entirely through the first movable contacts 61 and the first fixed contacts 51 (FIG. 15). No currents flow along the current limiter 200 as the second movable contacts 62 and the second fixed contacts 52 are decoupled.

No electric arcs arise between the movable contact assembly 6 and the fixed contact assembly 5 as the pole terminals 7, 8 are short-circuited.

In this situation, the current limiter 200 does not intervene.

FIG. 12 shows the switch pole 1 with the movable contact assembly 6 in the first intermediate position P₃, which is reached upon an initial slight movement of the movable contact assembly according to a rotation direction R about the rotation axis A₁ (FIGS. 11-12).

In this situation, the first movable contacts 61 are coupled to the first fixed contacts 51 and the second movable contacts 62 are coupled to the second fixed contacts 52.

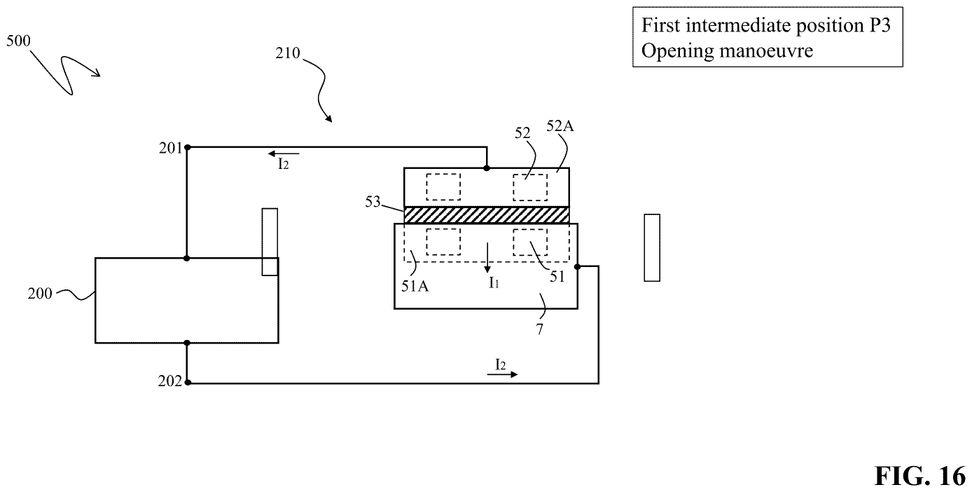

A pole current can still flow between the pole terminals 7, 8. Such a pole current is however split between a first current I₁ passing through the first movable contacts 61 and the first fixed contacts 51 and a second current I₂ passing through the second movable contacts 62, the second fixed contacts 52 and the current limiter 200 (FIG. 16).

The second current I₂ is generally lower than the first current I₁ as it circulates along a conductive path generally having a higher equivalent resistance.

No electric arcs arise between the movable contact assembly 6 and the fixed contact assembly 5 as the pole terminals 7, 8 are still short-circuited.

In this situation, the current limiter 200 does not intervene.

FIG. 13 shows the switch pole 1 with the movable contact assembly 6 in the second intermediate position P₄, which is reached upon a further movement of the movable contact assembly according to a rotation direction R (FIGS. 12-14).

In this situation, the first movable contacts 61 are decoupled from the first fixed contacts 51 while the second movable contacts 62 are coupled to the second fixed contacts 52.

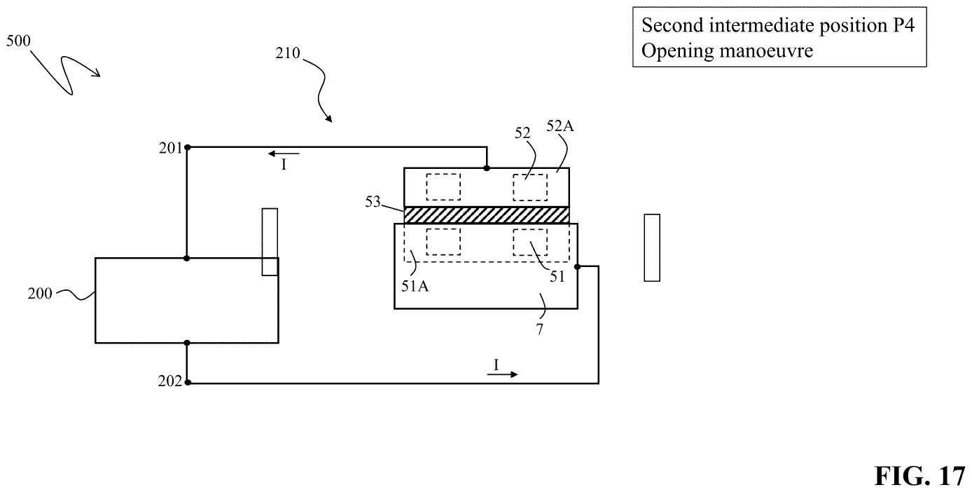

A pole current I can still flow along the switch pole between the pole terminals 7, 8 as these latter are still short-circuited. The pole current I passes entirely through the second movable contacts 62, the second fixed contacts 52 and the current limiter 200 (FIG. 17).

No currents flow along the first movable contacts 61 and the first fixed contacts 51 as these latter are decoupled.

No electric arcs arise between the movable contact assembly 6 and the fixed contact assembly 5 as the pole terminals 7, 8 are still short-circuited.

In this situation, the current limiter 200 intervenes to limit or break the current flowing along the switch pole as soon as the movable contact assembly 6 reaches the second intermediate position P₄.

If it is configured to limit the current passing through the switch pole, the current limiter 200 will continue to operate also when the movable contact assembly 6 moves from the second intermediate position P₄ to the second position P₂, until the current flowing along the switch pole is finally interrupted due to the separation of the movable contact assembly 6 from the fixed contact assembly 5.

If it is configured to break the current passing through the switch pole, the current limiter 200 will start breaking the current at this stage of the opening maneuver of the switching device 100.

If it is particularly fast to intervene (e.g., because it includes a switching circuit of the solid-state type), the current limiter 200 can complete its current breaking action while the second movable contacts 62 are still coupled with the second fixed contacts 52. In this case, the following separation of the second movable contacts 62 from the second fixed contacts 52 will occur substantially without the presence of electric arcs.

However, the current limiter 200 might be unable to complete its current breaking action while the second movable contacts 62 are still coupled with the second fixed contacts 52. In this case, the current limiter 200 will complete the intervention after the second movable contacts 62 decouple from the second fixed contacts 52 until the current flowing along the switch pole 1 is finally interrupted. In this case, electric arcs may develop between the movable contact assembly 6 and the fixed contact assembly 5.

Upon yet a further movement according to the rotation direction R (FIGS. 12-14), also the second movable contacts 62 decouple from the second fixed contacts 52 and the movable contact assembly 6 moves to the second position P₂ (open condition of the switch pole).

As the movable electric contacts 61, 62 decouple from the corresponding fixed electric contacts 51, 52 during the stage of the opening maneuver, a difference of voltage potential between the first and second pole terminals 7, 8 increases. At any time, the second pole terminal (and the movable contacts 61, 62) may have a positive voltage polarity while the first pole terminal 7 (and the fixed contacts 51, 52) may have a negative voltage polarity, or vice-versa). Since the dielectric distance between the movable contacts 61, 62 and the fixed contacts 51, 52 is quite short, electric arcs may develop between the movable contact assembly 6 and the fixed contact assembly 5 under separation. In this case, the arc-breaking elements 41 favors the quenching process of said electric arcs.

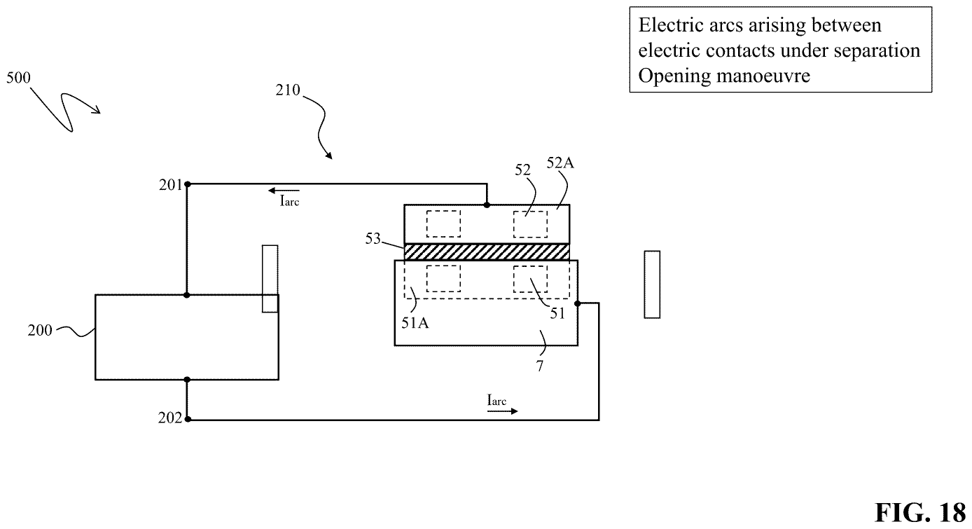

The possible onset of these electric arcs would allow arcing currents I_{arc} to circulate through the second movable contacts 62, the second fixed contacts 52 and the current limiter 200 (FIG. 18).

At this stage of the opening maneuver, however, the current limiter 200 has already intervened to limit or break the current flowing along the switch pole.

If it is configured to limit the current passing through the switch pole, the current limit device 200 effectively contributes to quench possible electric arcs arising between the movable contact assembly 6 and the fixed contact assembly 5 under separation as these arcing phenomena occur with a lower energy level and are therefore easier to be quenched.

If it is configured to break the current passing through the switch pole, the current limiter 200 may complete its current breaking action at this stage of the opening maneuver of the switching device 100. In this case, the intervention of the current limiter 200 causes the forced quenching of possible electric arcs arising between the movable contact assembly 6 and the fixed contact assembly 5 under separation as the arcing current I_{arc} cannot circulate through the switch pole anymore.

If the current limiter 200 has already completed its current breaking action before the second movable contacts 62 decouple from the corresponding second fixed contacts 52 (as the current limiter is very fast to intervene), no electric arcs arise as arcing currents cannot circulate through the switch pole. This final stage of the opening maneuver can thus occur without any arcing phenomena.

Finally, when the movable contact assembly 6 reaches the second position P₂ (open condition of the switch pole), the opening maneuver is complete. In this situation, possible arcing phenomena still in progress will continue their quenching process thanks to the arc-breaking elements 41 and the current limiter 200.

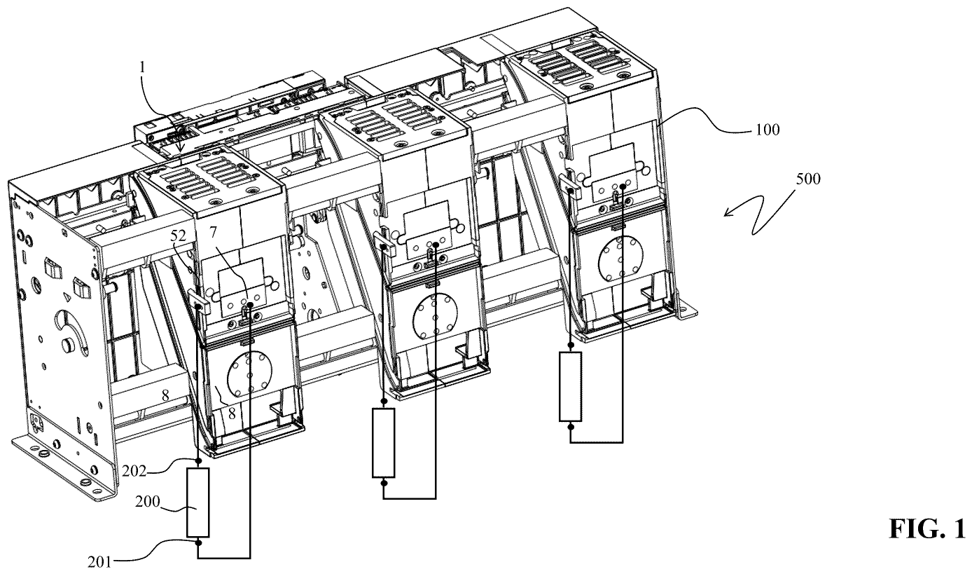

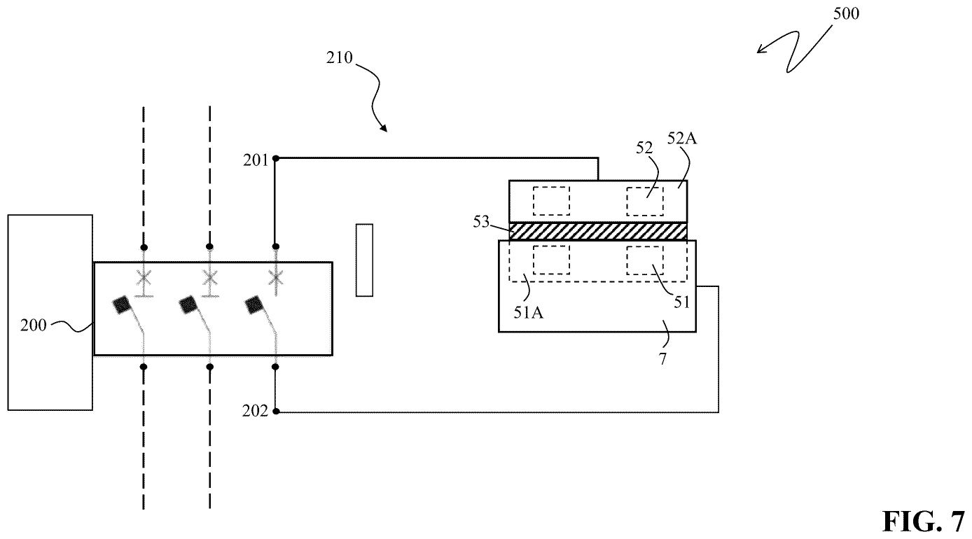

According to some embodiments of the present disclosure, the current limiter 200 comprises an auxiliary switching device of the electro-mechanical type, for example a circuit breaker (FIGS. 1 and 7). In this case, each current limiter 200 includes at least a switch pole 200 of the auxiliary switching device. The switch poles 1 of the auxiliary switching device can be rated much less than in normal use in a switching device as they operate during an opening maneuver of the switching device 100.

The electro-mechanical switching device 200 may be of the self-acting type for what concerns the execution of an opening maneuver. In this case, the transition from a closed state to an open state (opening maneuver) occurs by exploiting electrodynamic forces generated by the circulation of current along the switch poles. The current breaking maneuver of a switching device of this type thus occurs in a very short time (fast switching) without receiving an input control signal or an external power supply (non-controllable opening maneuver).

As an alternative, the electro-mechanical switching device 200 may also be of the fully controllable type. In this case, any transition from a closed state to an open state (opening maneuver) or from an open state to a closed state (closing maneuver) occurs in response to receiving a suitable input control signal, which causes the activation of a driving mechanism moving the movable contacts or tripping the motion of the movable contacts of each switch pole.

In general, the electro-mechanical switching device 200 may be realized according to solutions of known type. Therefore, in the following, it will be described only with reference to the aspects of interest of the present disclosure for the sake of brevity.

According to other embodiments of the present disclosure, the current limiter 200 comprises at least a switching circuit of the solid-state type for each switch pole of the switching device 100 (FIGS. 1 and 6).

Each switching circuit 200 includes one or more switching components based on semiconductor materials. In general, said semiconductor switching components may be of conventional type, such as, for example, Power MOSFETs, JFETs, Insulated Gate Bipolar Transistors (“IGBTs”), Gate Turn-Off Thyristors (GTOs), Integrated Gate-Commutated Thyristors (“IGCTs”), or the like.

In response to receiving suitable input control signals, each solid-state switching device 200 can reversibly switch between an on-state, at which it conducts a current, and an off-state, at which it blocks a current.

A solid-state switching circuit 200 is turned off when it switches from an on-state to an off-state and it is turned on when it switches from an off-state to an on-state.

The transition from an on-state to an off-state of a solid-state switching circuit 200 is normally very fast. Each solid-state switching circuit 200 may thus be capable to interrupt the current flowing along the corresponding switch pole 1 of the switching device 100 before the second movable contacts 62 decouple from the corresponding second fixed contacts 52. The opening maneuver of the switching device 100 would in this case be carried out without the occurrence of arcing phenomena.

In general, the solid-state switching circuits 200 may be realized according to solutions of known type. Therefore, in the following, they will be described only with reference to the aspects of interest of the present disclosure for the sake of brevity.

According to other embodiments of the present disclosure, the current limiter 200 comprises at least a fuse circuit 200 for each switch pole of the switching device 100 (FIGS. 1 and 6).

Each fuse circuit 200 can be conveniently configured to interrupt the flow of current passing therethrough when the specific energy (I²t) of the flowing current exceeds a certain threshold. In practice, each fuse circuit 200 can be configured to intervene only if high energy arcing phenomena are likely to occur during an opening maneuver of the switching device 100. Obviously, a fuse circuit 200 should be replaced after the intervention.

In general, the fuse circuits 200 may be realized according to solutions of known type. Therefore, in the following, they will be described only with reference to the aspects of interest of the present disclosure for the sake of brevity.

According to other embodiments of the present disclosure, the current limiter 200 comprises at least resistive circuit (e.g., a rheostat circuit) or a resonant circuit 200 (e.g., a RLC circuit in different configurations) for each switch pole of the switching device 100 (FIGS. 1 and 6).

Each resistive circuit or resonant 200 can be conveniently configured to increase the overall impedance of the conductive path of the current passing through the corresponding switch pole of the switching device 100, during an opening maneuver of this latter. In this way, lower energy arcing phenomena are likely to occur during an opening maneuver of the switching device 100 and possible electric arcs between the electric contacts of the switch poles of the switching device 100 may be quenches more easily.

In general, the resistive or resonant circuits 200 may be realized according to solutions of known type. Therefore, in the following, they will be described only with reference to the aspects of interest of the present disclosure for the sake of brevity.

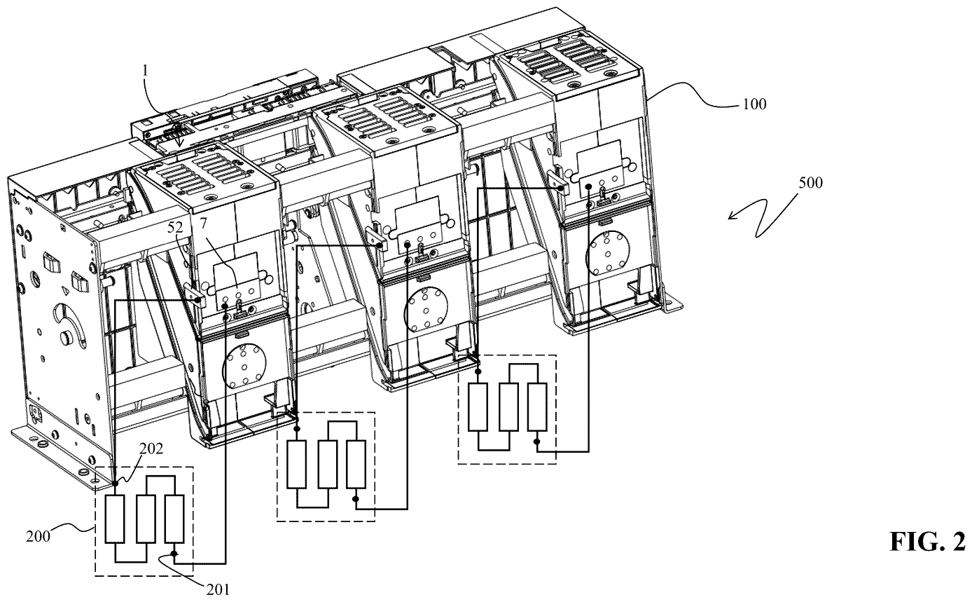

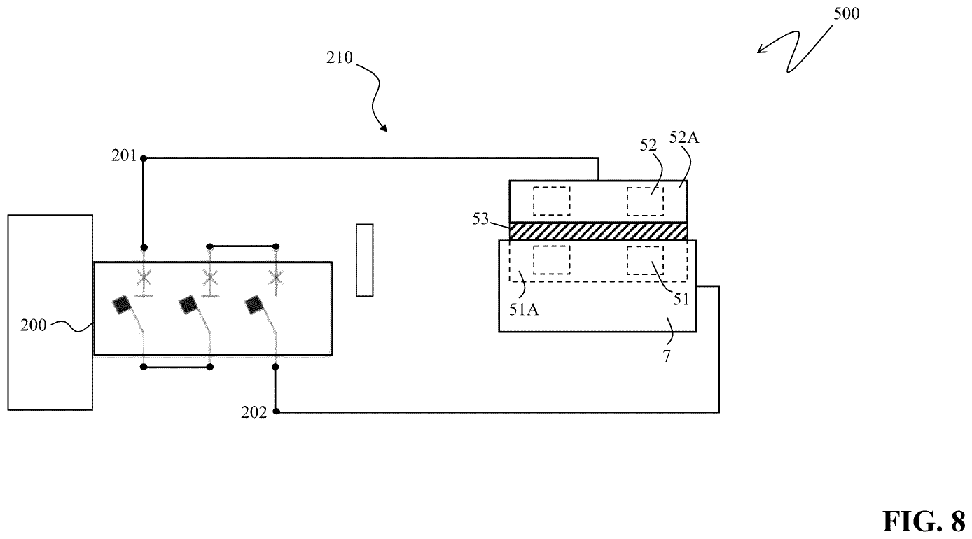

According to yet further embodiments of the present disclosure, the current limiter 200 comprises an auxiliary switching device 200 (e.g., a circuit breaker) of the electro-mechanical type for each switch pole 1 of the switching device 100 (FIGS. 2 and 8).

In principle, each switching device 200 may have a single switch pole electrically connected in series with the second electric contacts 52 and the first pole terminal 7 of the corresponding switch pole of the switching device 100 (the other switch poles of the switching device 200 may be kept floating).

In some embodiments, however, each auxiliary switching device 200 has a plurality of switch poles electrically connected in series with the second electric contacts 52 and the first pole terminal 7 of the corresponding switch pole of the switching device 100.

This solution is quite advantageous as it allows increasing the operating voltage at which the switching apparatus 500 can operate. Each current limiter 200 can in fact bear higher voltage potential differences during an opening maneuver of the switching apparatus 100, particularly when the second movable contacts 62 of each switch pole decouple from the corresponding second fixed contacts 52 (transition between the operating positions P₄ and P₂ of the movable contact assembly 6).

In general, the electromechanical switching devices 200 may be realized according to solutions of known type. Therefore, in the following, they will be described only with reference to the aspects of interest of the present disclosure for the sake of brevity.

According to other embodiments, the current limiter 200 comprises a hybrid switching circuit including at least an electromechanical switching device combined with at least a switching device of the solid-state type based on semiconductor. Such a hybrid switching circuit is electrically connected to a corresponding switch pole of said switching device.

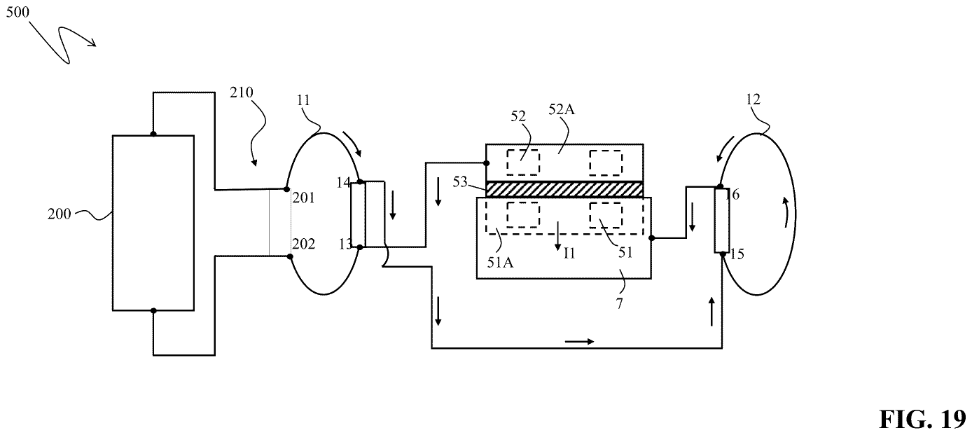

According to some embodiments of the present disclosure (FIG. 19), the switching device 100 comprises, for each switch pole 1, a magnetic field generation arrangement configured to generate a magnetic field, during an opening maneuver of the switching device.

Each magnetic field generation arrangement includes a first coil conductor 11 and a second coil conductor 12 wound around a winding axis parallel to the rotation axis A₁ of the movable contact assembly 6.

The first and second coil conductors 11, 12 are conveniently arranged according to a Helmholtz coil configuration. They are thus centered on their winding axis, spaced one from another along said winding axis and electrically connected in series, so that a same current flows along them according to concordant directions.

In some embodiments, the first and second coil conductors 11, 12 are arranged at opposite lateral walls of the insulating casing of the switch pole, outside the internal volume of the switch pole.

The first and second coil conductors 11, 12 are electrically connected in series with the second fixed contacts 52 of the switch pole 1, the first pole terminal 7 of the switch pole 1 and a corresponding current limiter 200.

FIG. 19 shows a schematic circuit view of the switching apparatus, for a generic electric phase, according to this embodiment of the present disclosure.

For each electric phase, the switching apparatus 500 comprises a switch pole 1 of the switching device 100 and a current limiter 200 electrically connected one to another.

The switch pole 1 includes a magnetic field generation arrangement including the first and second coil conductors 11, 12.

The first and second coil conductors 11, 12 have first and second coil terminals 13, 14 and third and fourth coil terminals 15, 16 respectively.

The first coil terminal 13 of the first coil conductor 11 is electrically connected to the second fixed contacts 52 of the switch pole 1, the second coil terminal 14 of the first coil conductor 11 is electrically connected to the third coil terminal 15 of the second coil conductor 12 while the fourth coil terminal 16 of the second coil conductor 12 is electrically connected to the first pole terminal 7.

The first coil terminal 13 of the first coil conductor 11 is electrically connected with the second terminal 202 of the current limiter 200 while the second coil terminal 14 of the first coil conductor 11 is electrically connected with the first terminal 201 of the of the current limiter 200.

As it is apparent, the second fixed contacts 52, the first coil conductor 11, the current limiter 200, the second coil conductor 12 and the first pole terminal 7 form a series circuit 210, along which a current can flow during an opening maneuver of the switching device 100.

The magnetic field generation arrangement generates a magnetic field, during an opening maneuver of the switching device, when a current flows through the second movable contacts 62 of the movable contact assembly 6 and the second fixed contacts 52 of the fixed contact assembly 5 (therefore along the above-mentioned series circuit 210).

In accordance to the operation of a generic electric phase the switching apparatus explained above, a current circulates along the coil conductors 11, 12 when the movable contact assembly 6 of the corresponding switch pole of the switching device 100 moves from the first intermediate position P₃ to the second intermediate position P₄ and, possibly, when the movable contact assembly 6 moves from the second intermediate position P₄ to the second position P₂ (if arcing phenomena occur between the electric contacts of the switch pole).

When a current flows along the coil conductors 11, 12 a magnetic field is generated and possible electric arcs arising between the fixed contact assembly 5 and the movable contact assembly 6 under separation (when the second movable contact 62 decouple from the second fixed contact 52) are affected by a magnetic force (Lorentz force) directed towards the arc-extinguishing region 4 of the switch pole. Such a magnetic force makes said electric arcs displace towards the arc extinguishing region 4.

In practice, possible electric arcs arising between the fixed contact assembly 5 and the movable contact assembly 6 under separation are “blown” by the generated magnetic field towards the arc extinguishing region 4. They can thus distribute uniformly among the arc-breaking elements 41 of the arc chamber 40, which can efficiently exert their quenching action on them.

The magnetic field generated by the magnetic field generation arrangement allows confining more efficiently the electric arcs in the arc extinguishing region 4, thereby reducing the probability of re-strikes towards other conductive parts of the switch pole.

Even if the magnetic field generation arrangement is present, the current limiter 200 electrically connected to the switch pole behaves as described above.

The current limiter 200 will thus limit or break a current flowing along the series circuit including the second fixed contacts 52, the first coil conductor 11, the current limiter 200, the second coil conductor 12 and the first pole terminal 7, when the first movable electric contacts 61 of the switch pole 1 decouples from the corresponding first fixed electric contacts 51, more particularly when the movable contact assembly reaches the second intermediate position P₄ and moves from the second intermediate position P₄ to the second position P₂.

In general, the above-mentioned magnetic field generation arrangement may be realized according to solutions of known type. Therefore, in the following, they will be described only with reference to the aspects of interest of the present disclosure for the sake of brevity.

The switching apparatus, according to the present disclosure, shows relevant advantages.

The current limiter 200 operatively associated to the switch pole of the switching device 100 provides or remarkably favors an efficient quenching process of possible electric arcs arising between the electric contacts under separation, during an opening maneuver of the switching device.

The arc chamber 40 and, more generally, the internal components of the switch poles of the switching device 100 are subject to lower mechanical and thermal stresses with a consequent prolongation of their lifetime.

Additionally, the current limiting or breaking action of the current limiter 200 allows reducing the probability of arcing strikes towards other conductive components of the switch poles of the switching device 100, during an opening maneuver of this latter.

The switching apparatus of the present disclosure has a relatively simple and compact structure, relatively easy to manufacture at industrial level, at competitive costs compared to the currently available solutions on the market.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A switching apparatus comprising a switching device comprising one or more switch poles, wherein a switch pole of the switching device comprises:
a first pole terminal and a second pole terminal, wherein the first pole terminal and the second pole terminal are each couplable with corresponding line conductors of an electric line;
a fixed contact assembly including a plurality of fixed electric contacts electrically connected to the first pole terminal, the fixed electric contacts including one or more first fixed contacts and one or more second fixed contacts electrically insulated from the first fixed contacts;
a movable contact assembly including a plurality of movable electric contacts electrically connected to the second pole terminal, the movable electric contacts including one or more first movable contacts and one or more second movable contacts, wherein the movable contact assembly is reversibly movable around a rotation axis, so that the first movable contacts can be coupled to or decoupled first fixed contacts and so that the second movable contacts are reversibly couplable with the second fixed contacts, when the movable contact assembly moves about the rotation axis; and
a current limiter electrically connected in series with the second fixed contacts and the first pole terminal of the switch pole,
wherein the current limiter is configured to limit or break a current flowing along a series circuit including at least the second fixed contacts, the current limiter, and the first pole terminal, during an opening maneuver of the switching device, when the first movable electric contacts decouple from the first fixed contacts.

2. The switching apparatus, according to claim 1, wherein:
the movable contact assembly of the switch pole is reversibly movable, about the rotation axis, between a first position, which corresponds to a closed condition of the switch pole, and a second position, which corresponds to an open condition of the switch pole,
when the movable contact assembly is in the first position:
the first movable contacts are coupled to the first fixed contacts, and
the second movable contacts are decoupled from the second fixed contacts; and
when the movable contact assembly is in the second position:
the first movable contacts are decoupled from the first fixed contacts, and
the second movable contacts are decoupled from the second fixed contacts.

3. The switching apparatus, according to claim 2, wherein during an opening maneuver of the switching device, the movable contact assembly moves from the first position to a first intermediate position, in which:
the first movable contacts are coupled to the first fixed contacts, and
the second movable contacts are coupled to the second fixed contacts.

4. The switching apparatus, according to claim 3, wherein during an opening maneuver of the switching device, the movable contact assembly subsequently moves from the first intermediate position to a second intermediate position, in which:
the first movable contacts are decoupled from the first fixed contacts; and
the second movable contacts are coupled to the second fixed contacts.

5. The switching apparatus, according to claim 4, wherein:
during an opening maneuver of the switching device, the movable contact assembly subsequently moves from the second intermediate position to the second position, and
the current limiter electrically connected to the switch pole is configured to limit or break a current flowing along the series circuit including at least the second fixed contacts, the current limiter, and the first pole terminal, when the movable contact assembly reaches the second intermediate position and moves from the second intermediate position to the second position.

6. The switching apparatus, according to claim 1, further comprising an auxiliary switching device of the electro-mechanical type electrically connected to the switch poles of the switching device, the current limiter including at least a switch pole of the auxiliary switching device.

7. The switching apparatus, according to claim 1, wherein the current limiter includes at least an auxiliary switching device of the electro-mechanical type electrically connected to a corresponding switch pole of the switching device.

8. The switching apparatus, according to claim 7, wherein the auxiliary switching device comprises a plurality of switch poles electrically connected in series.

9. The switching apparatus, according to claim 1, wherein the current limiter includes at least a switching circuit of the solid-state type electrically connected to a corresponding switch pole of the switching device.

10. The switching apparatus, according to claim 1, wherein the current limiter includes a fuse circuit electrically connected to a corresponding switch pole of said switching device.

11. The switching apparatus, according to claim 1, wherein the current limiter includes a resistive circuit electrically connected to a corresponding switch pole of the switching device.

12. The switching apparatus, according to claim 1, wherein the current limiter includes a resonant circuit electrically connected to a corresponding switch pole of the switching device.

13. The switching apparatus, according to claim 1, wherein:
the current limiter includes a hybrid switching circuit electrically connected to a corresponding switch pole of the switching device, and
the hybrid switching circuit comprises at least a switching device of the electro-mechanical type and at least a switching circuit of the solid-state type.

14. The switching apparatus, according to claim 1, further comprising:
for each switch pole of the switching device, a magnetic field generation arrangement including a first coil conductor and a second coil conductor wound around a winding axis parallel to the rotation axis of the movable contact assembly, wherein:
the first and second coil conductors are spaced one from another along the winding axis and are electrically connected in series with the second fixed contacts, a current limiter and the first pole terminal, and
the current limiter is configured to limit or break a current flowing along a series circuit including at least the second fixed contacts, the first coil conductor, the current limiter, the second coil conductor and the first pole terminal, during an opening maneuver of the switching device, when the first movable electric contacts decouple from the first fixed contacts.
